(19) United States
(12) Patent Application Publication
(10) Pub. No.: US 2025/0330653 A1
(43) Pub. Date: Oct. 23, 2025

(54) NEURAL NETWORK-BASED IN-LOOP FILTER

(71) Applicant: GUANGDONG OPPO MOBILE TELECOMMUNICATIONS CORP., LTD., Dongguan (CN)

(72) Inventors: Cheolkon JUNG, Dongguan (CN); Hao ZHANG, Dongguan (CN)

(21) Appl. No.: 19/254,516

(22) Filed: Jun. 30, 2025

Related U.S. Application Data
(63) Continuation of application No. PCT/CN2023/079635, filed on Mar. 3, 2023.

(30) Foreign Application Priority Data
Jan. 3, 2023 (WO) PCT/CN2023/070243

(51) Int. Cl. H04N 19/82; H04N 19/124; H04N 19/154; H04N 19/167; H04N 19/172; H04N 19/176; H04N 19/186; H04N 19/42; H04N 19/61

(52) U.S. Cl. CPC H04N 19/82; H04N 19/124; H04N 19/154; H04N 19/167; H04N 19/172; H04N 19/176; H04N 19/186; H04N 19/42; H04N 19/61

(57) ABSTRACT

A method for enhancing quality of a frame is provided. The frame and auxiliary information associated with the frame are received by a processor. A neural network (NN)-based in-loop filter is applied to the frame based on the auxiliary information to enhance the quality of the frame. The NN-based in-loop filter includes a backbone part including at least one transformer block at least one residual-attention block (RAB). The at least one RAB includes at least one attention block receiving at least part of the auxiliary information.

### CROSS-REFERENCE TO RELATED APPLICATIONS

This application is a continuation of International Application No. PCT/CN2023/079635 filed on Mar. 3, 2023, which is based on and claims priority to and benefits of International Application No. PCT/CN2023/070243, filed on Jan. 3, 2023. The above-referenced applications are incorporated herein by reference in their entirety.

### TECHNICAL FIELD

Embodiments of the present disclosure relate to video coding.

### BACKGROUND

Digital video has become mainstream and is used in a wide range of applications including digital television, video telephony, and teleconferencing. These digital video applications are feasible because of the advances in computing and communication technologies, as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method for enhancing quality of a frame is provided. The frame and auxiliary information associated with the frame are received by a processor. A neural network (NN)-based in-loop filter is applied to the frame based on the auxiliary information to enhance the quality of the frame. The NN-based in-loop filter includes three parts: feature extraction, backbone, and reconstruction. The backbone part includes residual-attention blocks (RABs) and transformer blocks, and an attention block is used in RABs to better refine features by introducing auxiliary information.

According to another aspect of the present disclosure, a system for enhancing quality of a frame includes a memory configured to store instructions and a processor coupled to the memory. The processor is configured to, upon executing the instructions, receive the frame and auxiliary information associated with the frame, and apply a NN-based in-loop filter to the frame based on the auxiliary information to enhance the quality of the frame. The NN-based in-loop filter includes a backbone part including RABs and transformer blocks, and an attention block is used in the RABs to better refine features by introducing auxiliary information.

According to still another aspect of the present disclosure, a non-transitory computer-readable device is provided. The non-transitory computer-readable device has instructions stored thereon that, when executed by at least one computing device, cause the at least one computing device to perform operations. The operations include receiving a frame and auxiliary information associated with the frame, and applying a NN-based in-loop filter to the frame based on the auxiliary information to enhance the quality of the frame. The NN-based in-loop filter includes a backbone part including RABs and transformer blocks, and an attention block is used in the RABs to better refine features by introducing auxiliary information.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of a video encoder with an in-loop filter, according to some embodiments of the present disclosure.

FIG. 2 illustrates a block diagram of an exemplary encoding system, according to some embodiments of the present disclosure.

FIG. 3 illustrates a block diagram of an exemplary decoding system, according to some embodiments of the present disclosure.

FIG. 4 illustrates a block diagram of an exemplary NN-based in-loop filter of the video encoder of FIG. 1, according to some embodiments of the disclosure.

FIG. 5A illustrates a detailed block diagram of an exemplary feature extraction part for luma component of the NN-based in-loop filter of FIG. 4, according to some embodiments of the present disclosure.

FIG. 5B illustrates a detailed block diagram of another exemplary feature extraction part for chroma component of the NN-based in-loop filter of FIG. 4, according to some embodiments of the present disclosure.

FIG. 6A illustrates a detailed block diagram of an exemplary reconstruction part for luma component of the NN-based in-loop filter of FIG. 4, according to some embodiments of the present disclosure.

FIG. 6B illustrates a detailed block diagram of another exemplary reconstruction part for chroma component of the NN-based in-loop filter of FIG. 4, according to some embodiments of the present disclosure.

FIG. 7A illustrates a detailed block diagram of an exemplary backbone part of the NN-based in-loop filter of FIG. 4, according to some embodiments of the present disclosure.

FIG. 7B illustrates a detailed block diagram of another exemplary backbone part of the NN-based in-loop filter of FIG. 4, according to some embodiments of the present disclosure.

FIG. 8 illustrates a detailed block diagram of an exemplary residual-attention block (RAB) of the backbone part of FIGS. 7A and 7B, according to some embodiments of the present disclosure.

FIG. 9 illustrates a detailed block diagram of an exemplary residual block of the RAB of FIG. 8, according to some embodiments of the present disclosure.

FIG. 10 illustrates a detailed block diagram of an exemplary attention block of the RAB of FIG. 8, according to some embodiments of the present disclosure.

FIG. 11 illustrates a detailed block diagram of an exemplary channel attention block of the attention block of FIG. 10, according to some embodiments of the present disclosure.

FIG. 12A illustrates a detailed block diagram of an exemplary intensity channel attention block of the channel attention block of FIG. 11, according to some embodiments of the present disclosure.

FIG. 12B illustrates a detailed block diagram of an exemplary contrast channel attention block of the channel attention block of FIG. 11, according to some embodiments of the present disclosure.

FIG. 13 illustrates a detailed block diagram of an exemplary spatial attention block of the attention block of FIG. 10, according to some embodiments of the present disclosure.

FIG. 14 illustrates a detailed block diagram of an exemplary transformer block (TB) of the backbone part of FIGS. 7A and 7B, according to some embodiments of the present disclosure.

FIG. 15 illustrates a flow chart of an exemplary method of enhancing quality of a frame, according to some embodiments of the present disclosure.

FIG. 16 illustrates a block diagram of an exemplary in-loop filter used for training, according to some embodiments of the present disclosure.

FIG. 17A illustrates a block diagram of an in-loop filter training strategy.

FIG. 17B illustrates a block diagram of an exemplary in-loop filter training strategy, according to some embodiments of the present disclosure.

FIGS. 18A to 18D illustrate the visual quality comparison of exemplary test datasets of the NN-based in-loop filter of FIG. 4.

FIGS. 19A-19C illustrate test results of peak-signal-to-noise ratio (PSNR) versus bit-rate for video encoding by test datasets of FIGS. 18A to 18D using the NN-based in-loop filter of FIG. 4, according to some embodiments of the present disclosure.

FIG. 20 illustrates a flow chart of an exemplary method of training the NN-based in-loop filter of FIG. 4, according to some embodiments of the present disclosure.

FIG. 21 illustrates compression artifacts with different quantization parameters (QPs).

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block,” “unit,” “portion,” and “component” may be used interchangeably.

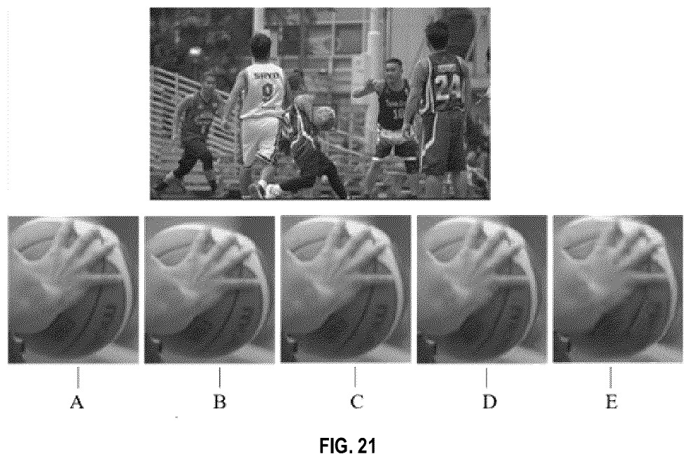

For existing video compression methods, such as HEVC and VVC, blocking and quantization are performed during the encoding process, resulting in irreversible information loss and various compression artifacts, such as blocking, blurring, and banding. This phenomenon is especially pronounced when the compression ratio, e.g., represented by quantization parameters (QP), is high. For example, compression artifacts are shown in FIG. 21 with different QPs, e.g., for A, QP=22; for B, QP=27; for C, QP=32; for D, QP=37; and for E, QP=42. With the increase of QP, the artifacts become more and more serious, and the image quality becomes worse.

Currently, there are many methods to improve the quality of compressed images and videos based on deep learning, mainly to reduce blocking artifacts, banding artifacts, and noise. In one example, versatile video coding (VVC) employs in-loop filters in the encoder to suppress compression artifacts and reduce distortion. These in-loop filters may include a deblocking filter (DBF), a sample adaptive offset (SAO), and an adaptive loop filter (ALF), just to name a few. DBF and SAO are two filters designed to reduce artifacts caused by the encoding process. DBF focuses on visual artifacts at block boundaries, while SAO complementarily reduces artifacts that may arise from the quantization of transform coefficients within blocks. ALF may enhance the adaptive filter of the reconstructed signal, reducing the mean square error (MSE) between the original and reconstructed samples using a Wiener-based adaptive filter. Although these filters greatly mitigate compression artifacts, they are handcrafted and developed based on signal processing theory assuming stationary signals. Since natural video sequences are usually non-stationary, their performance is limited. Therefore, the loop filters in VVC still have a lot of room for improvement.

With the development of deep learning, various image and video quality enhancement methods based on CNNs have emerged. Recently, some video encoders have been designed with NN-based in-loop filters, which include a trained CNN filter embedded in the VVC loop. This may be accomplished by inserting loop filter components or replacing some loop filter components.

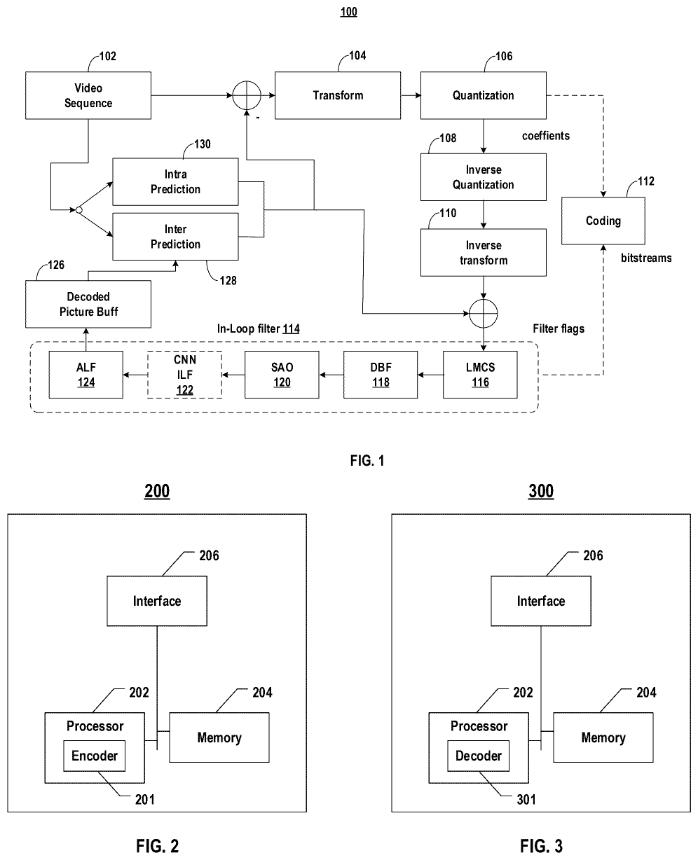

FIG. 1 illustrates a block diagram of a video encoder 100 with an in-loop filter 114 having a NN-based in-loop filter (CNN ILF) 122, according to some embodiments of the present disclosure. Video encoder 100 may include, e.g., a video sequence component 102, a transform component 104, a quantization component 106, an inverse quantization component 108, an inverse transform component 110, a coding component 112, in-loop filter 114, a decoded picture buffer 126, an inter-prediction component 128, and an intra-prediction component 130, just to name a few. In-loop filter 114 may include, e.g., a luma mapping with chroma scaling component (LMCS) 116, a DBF 118, an SAO 120, CNN ILF 122, and an ALF 124.

Some video encoders use a QP-variable NN-based in-loop filter for VVC intra-coding. To avoid training and deployment in multiple networks, these encoders use a QP attention module (QPAM), which captures compression noise levels for different QPs and emphasize meaningful features along channel dimensions. The QPAM may be embedded in a residual block that is part of a network architecture, which is designed for the controllability of different QPs. To fine tune the network, these video encoders may use a focal mean square error (MSE) loss function.

However, these video encoders did not use additional auxiliary information (a.k.a., side information) as the input; thus, the performance of this network was limited. Meanwhile, the direct fusion of shallow features into the backbone part (a.k.a. backend) of the network limits the performance of the model; therefore, the performance of this network is further degraded.

In other video encoders, a dense residual convolutional neural network (DRN) based in-loop filter may be used for VVC. These video encoders use a residual learning component, dense shortcuts, and bottleneck layers to solve the problems of gradient vanishing, encourage feature reuse, and reduce computational resources, respectively. Unfortunately, the performance of these video encoders is unable to achieve a desirable trade-off between complexity and performance.

In still other existing video encoders, a NN-based filter may be employed to enhance the quality of VVC intra-coded frames by taking auxiliary information, such as partitioning and prediction information as inputs. For chroma, the auxiliary information further includes luma samples. Although this filter achieves adequate performance on the Y channel, the performance on other channels (e.g., U and V channels for luma) is relatively low and with an undesirable encoding latency and high complexity.

To overcome these and other challenges, the present disclosure provides an improved NN-based in-loop filter (e.g., CNN ILF 122 in FIG. 1), which is based on the residual block (resblock) and transformer block in its backbone part. NN-based in-loop filter 122 can achieve improved performance with lower computational complexity as compared to other NN-based in-loop filters.

According to some aspects of the present disclosure, NN-based in-loop filter 122 is suitable for various image samples and slice types, such as two sample types (luma and chroma) and two slice types (I-slice and B-slice). According to the different types of samples and slices, different feature extraction networks, backbone networks, and reconstruction networks may be designed to enhance the applicability of NN-based in-loop filter 122.

According to some aspects of the present disclosure, the backbone part of NN-based in-loop filter 122 uses residual blocks and transformer blocks to extract and process features. For example, residual attention blocks may be first used to extract shallow features of the input and capture the correlation between local features. Then, transformer blocks may be utilized to capture the long-range correlation between features, thus enabling the NN-based in-loop filter disclosed herein to acquire informative residual features.

According to some aspects of the present disclosure, auxiliary information, such as partition map, prediction map, and QP map of the reconstruction frame, to guide NN-based in-loop filter 122 to adaptively select and refine important features. For example, for the spatial attention block, partition map and QP map may be introduced to better locate the region with blocking effects and distortion. For the channel attention block, QP map may be introduced to combine intensity attention and contrast attention.

Consistent with the scope of the present disclosure, NN-based in-loop filter 122 is based on residual block and transformer block, which are used to work together with DBF and SAO within in-loop filter 114 to improve the objective quality of reconstruction frames. In some embodiments, four models for different types of inputs: luma model for I-Slice, chroma model for I-Slice, luma model for B-Slice, and chroma model for B-Slice, are introduced and can be handled by different designs of NN-based in-loop filter 122. In some embodiments, in terms of network architecture, residual block and transformer block are combined as the backbone network to achieve better performance with acceptable complexity. In some embodiments, more auxiliary information, such as partition map and QP map, is introduced into the attention block to achieve effective feature refinement. In some embodiments, multi-stage progressive training and iterative training are used to maximize the learning ability of the proposed network. Therefore, NN-based in-loop filter 122 can achieve a good trade-off between complexity and performance. Additional details of NN-based in-loop filter 122 and the exemplary training strategy of its model are provided below in connection with FIGS. 2-20.

It is understood that although NN-based in-loop filter 122 is mainly used to enhance the quality of compressed images, the CNN used in NN-based in-loop filter 122 can also be used as a post-processing after decoding to enhance the quality of the decoded frame. Moreover, if the downsampling convolution in feature extraction were removed, the CNN used in NN-based in-loop filter 122 can be used for image super-resolution as well.

FIG. 2 illustrates a block diagram of an exemplary encoding system 200, according to some embodiments of the present disclosure. FIG. 3 illustrates a block diagram of an exemplary decoding system 300, according to some embodiments of the present disclosure. Each system 200 or 300 may be applied or integrated into various systems and apparatus capable of data processing, such as computers and wireless communication devices. For example, system 200 or 300 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 2 and 3, system 200 or 300 may include a processor 202, a memory 204, and an interface 206. These components are shown as connected to one another by a bus, but other connection types are also permitted. It is understood that system 200 or 300 may include any other suitable components for performing functions described here.

Processor 202 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 2 and 3, it is understood that multiple processors can be included. Processor 202 may be a hardware device having one or more processing cores. Processor 202 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 204 can broadly include both memory (a.k.a, primary/system memory) and storage (a.k.a., secondary memory). For example, memory 204 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 202. Broadly, memory 204 may be embodied by any computer-readable medium, such as a non-transitory computer-readable medium. Although only one memory is shown in FIGS. 2 and 3, it is understood that multiple memories can be included.

Interface 206 can broadly include a data interface and a communication interface that is configured to receive and transmit a signal in a process of receiving and transmitting information with other external network elements. For example, interface 206 may include input/output (I/O) devices and wired or wireless transceivers. Although only one memory is shown in FIGS. 2 and 3, it is understood that multiple interfaces can be included.

Processor 202, memory 204, and interface 206 may be implemented in various forms in system 200 or 300 for performing video coding functions. In some embodiments, processor 202, memory 204, and interface 206 of system 200 or 300 are implemented (e.g., integrated) on one or more system-on-chips (SoCs). In one example, processor 202, memory 204, and interface 206 may be integrated on an application processor (AP) SoC that handles application processing in an operating system (OS) environment, including running video encoding and decoding applications. In another example, processor 202, memory 204, and interface 206 may be integrated on a specialized processor chip for video coding, such as a GPU or ISP chip dedicated to image and video processing in a real-time operating system (RTOS).

As shown in FIG. 2, in encoding system 200, processor 202 may include one or more modules, such as an encoder 201 (a.k.a. pre-processing network). Although FIG. 2 shows that encoder 201 is within one processor 202, it is understood that encoder 201 may include one or more sub-modules that can be implemented on different processors located closely or remotely with each other. Encoder 201 (and any corresponding sub-modules or sub-units) can be hardware units (e.g., portions of an integrated circuit) of processor 202 designed for use with other components or software units implemented by processor 202 through executing at least part of a program, i.e., instructions. The instructions of the program may be stored on a non-transitory computer-readable medium, such as memory 204, and when executed by processor 202, it may perform a process having one or more functions related to video encoding, such as picture partitioning, inter prediction, intra prediction, transformation, quantization, filtering, entropy encoding, etc., as described below in detail.

Similarly, as shown in FIG. 3, in decoding system 300, processor 202 may include one or more modules, such as a decoder 301 (a.k.a., post-processing network). Although FIG. 3 shows that decoder 301 is within one processor 202, it is understood that decoder 301 may include one or more sub-modules that can be implemented on different processors located closely or remotely with each other. Decoder 301 (and any corresponding sub-modules or sub-units) can be hardware units (e.g., portions of an integrated circuit) of processor 202 designed for use with other components or software units implemented by processor 202 through executing at least part of a program, i.e., instructions. The instructions of the program may be stored on a non-transitory computer-readable medium, such as memory 204, and when executed by processor 202, it may perform a process having one or more functions related to video decoding, such as entropy decoding, inverse quantization, inverse transformation, inter prediction, intra prediction, filtering, as described below in detail.

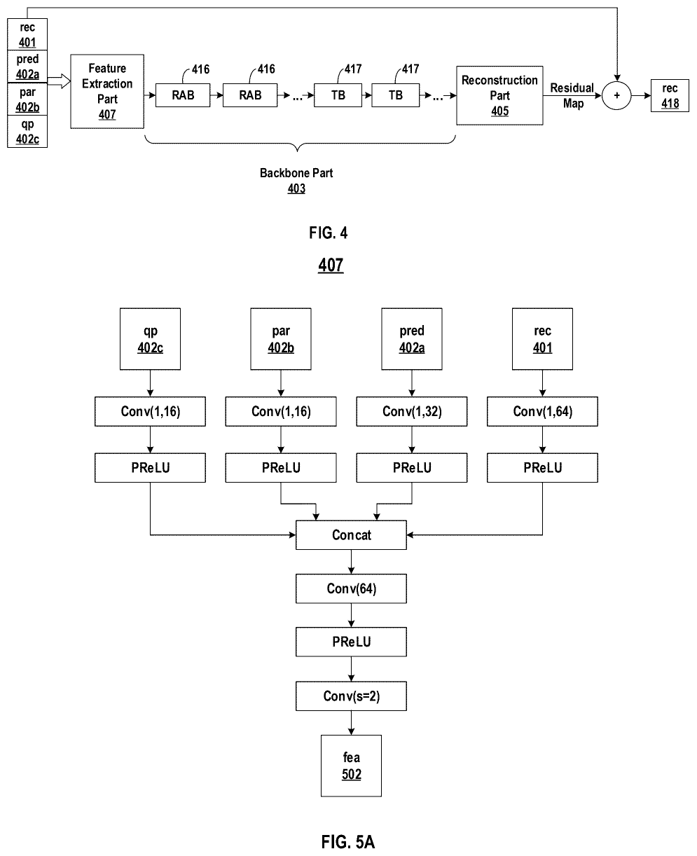

Referring back to FIG. 2, encoder 201 may be video encoder 100, which includes NN-based in-loop CNN filter 122, as described below in connection with FIGS. 4-20. FIG. 4 illustrates a block diagram of NN-based in-loop filter 122 of video encoder 100 of FIG. 1, according to some embodiments of the disclosure.

Referring to FIG. 4, NN-based in-loop filter 122 may include a feature extraction part 407, a backbone part 403, and a reconstruction part 405. Inputs into NN-based in-loop filter 122 may include, e.g., a reconstruction frame (rec) 401, a prediction map (pred) 402a associated with reconstruction frame 401, a partition map (par) 402b associated with reconstruction frame 401, and a QP map (qp) 402c associated with reconstruction frame 401, which are each generated by any suitable components of video encoder 100. Feature extraction part 407 is configured to extract features from reconstruction frame 401, prediction map 402a, partition map 402b, and QP map 402c. Backbone part 403 is configured to process the features based on RAB 416 and Transformer block 417 to generate global features of input features 502. Reconstruction part 405 is configured to reconstruct a residual map based on the global features and add it to reconstruction frame 401 to generate an enhanced reconstruction frame (rec) 418.

Reconstruction frame 401 is a reconstruction of the current video frame by video encoder 100 for quality enhancement. Information other than reconstruction frame 401, such as prediction map 402a, partition map 402b, and QP map 402c, is viewed as auxiliary information in the present disclosure, which can help NN-based in-loop filter 122 better enhance the quality of reconstruction frame 401. Prediction map 402a contains the prediction information of reconstruction frame 401 by video encoder 100. Since prediction map 402a is generated by the neighboring frame, the use of the prediction map 402a is equivalent to introducing the temporal information into NN-based in-loop filter 122, thus helping NN-based in-loop filter 122 to better locate and process the artifacts in the moving area. Partition map 402b represents the block information of reconstruction frame 401 and thus, can effectively help NN-based in-loop filter 122 to estimate the blocky area, thereby removing the block artifacts in reconstruction frame 401. QP map 402c is used to indicate the QP values used by reconstruction frame 401. QP map 402c is related to the distortion degree of reconstruction frame 401 and may improve the quality of the reconstruction frames at different QPs at reconstruction part 405.

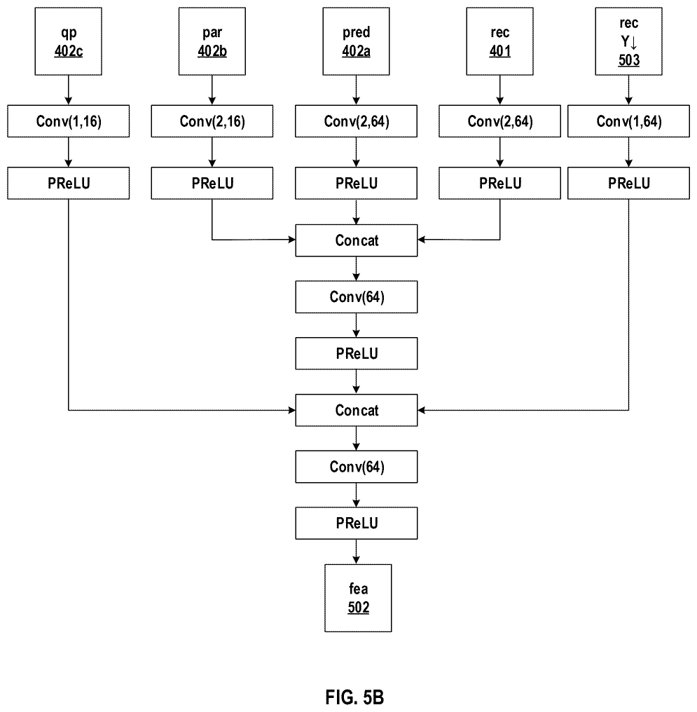

Based on different types of input reconstruction frames 401 (e.g., with different image samples and/or slice types), feature extraction part 407 may be implemented in various embodiments. In one example in which reconstruction frame 401 is a reconstruction frame of luma samples (e.g., in Y channel), FIG. 5A illustrates a detailed block diagram of feature extraction part 407 of NN-based in-loop filter 122 of FIG. 4, according to some embodiments of the present disclosure.

For reconstruction frame 401 of luma samples in FIG. 5A, the input auxiliary information includes prediction map 402a, partition map 402b, and QP map 402c each associated with reconstruction frame 401 of luma samples. Feature extraction part 407 in FIG. 5A is configured to extract features 502 (e.g., a feature map) from reconstruction frame 401 of luma samples, prediction map 402a, partition map 402b, and QP map 402c. In some embodiments, reconstruction part 405 in FIG. 5A includes multiple parallel standard convolutional layers (Conv(x, y)), and each parallel convolutional layer is used to integrate and extract the shallow features of its corresponding input. (x, y) of convolutional layers indicates the numbers of input channels and output channels of each convolutional layer and may vary for different inputs, for example, based on the features to be extracted from each input. Each parallel convolutional layer may be followed by a respective parametric rectified linear unit (PReLU). Afterward, the shallow features from different PReLUs may be concatenated using a concatenation layer (Concat) and fused using a convolutional layer with 64 output channels (Conv(64)) to obtain the fused shallow features. Then, a convolutional layer with stride 2 (Conv(s=2)) may be used to downsample the fused shallow features to reduce the computation complexity and to output features 502 (a.k.a, intermediate features).

In another example in which reconstruction frame 401 is a reconstruction frame of chroma samples (e.g., in U and V channels), FIG. 5B illustrates a detailed block diagram of feature extraction part 407 of NN-based in-loop filter 122 of FIG. 4, according to some embodiments of the present disclosure.

For reconstruction frame 401 of chroma samples in FIG. 5A, the input auxiliary information includes prediction map 402a, partition map 402b, and QP map 402c each associated with reconstruction frame 401 of chroma samples. Moreover, the inputs of feature extraction part 407 in FIG. 5B further includes reconstruction frame 503 of luma samples (rec Y↓). That is, the Y channel luma information of the same frame may be used to help extract features of chroma samples. Since the luma samples contain more information, it can be used to provide more accurate structure and texture information for feature extraction of chroma samples, so as to better improve the quality of the chroma samples. It is understood that, in general, the useful information in the luma samples is related to the QP value. For example, for larger QPs, feature extraction part 407 may need more structure information, while for smaller QPs, more detailed texture information may be more necessary.

Feature extraction part 407 in FIG. 5B is configured to extract features 502 from reconstruction frame 401 of chroma samples based on prediction map 402a, partition map 402b, and QP map 402c, as well as reconstruction frame 503 of luma samples. Different from the example in FIG. 5A, due to the different types of input information, a progressive fusion approach is used in FIG. 5B to obtain more accurate fusion features. In some embodiments, since chroma samples have strong correlation, they should be fused first. For example, shallow features from reconstruction frame 401 of chroma samples, prediction map 402a, and partition map 402b may be fused first to obtain chroma-related fusion shallow features. After that, shallow features from reconstruction frame 503 of luma samples and QP map 402c may be fused with chroma-related fusion shallow features using concatenation and convolution to obtain the final fusion shallow feature. Finally, a convolutional layer and PReLU may be used to downsample the final fused shallow features to reduce the computation complexity and to output features 502 (a.k.a, intermediate features).

The above-described examples of FIGS. 5A and 5B can be used for I-slice input. It is understood that in some examples, for B-slice input, partition map 402b may not be used as input auxiliary information of feature extraction part 407.

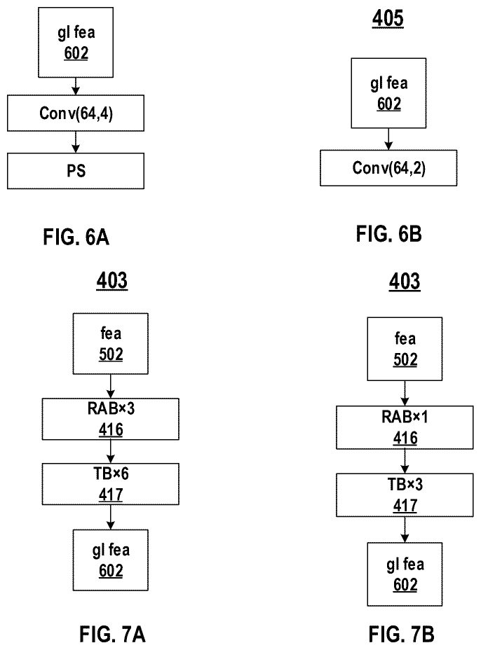

Based on different types of input reconstruction frames 401 (e.g., with different image samples and/or slice types), reconstruction part 405 may be implemented in various embodiments as well. In one example in which reconstruction frame 401 is a reconstruction frame of luma samples (e.g., in Y channel), FIG. 6A illustrates a detailed block diagram of reconstruction part 405 of NN-based in-loop filter 122 of FIG. 4, according to some embodiments of the present disclosure. Reconstruction part 405 in FIG. 6A may receive global features (gl fea) 602 from backbone part 403 and use a 64×4 convolutional layer (Conv(64,4)) to reduce the channel dimension of the global features 602. Then, reconstruction part 405 may use a pixel shuffle (PS) layer to upsample the dimension-reduced features to obtain a residual map. Finally, the obtained residual map may be added by a summation layer (shown in FIG. 4) to reconstruction frame 401, thereby generating an enhanced reconstruction frame 418.

In another example in which reconstruction frame 401 is a reconstruction frame of chroma samples (e.g., in U and V channels), FIG. 6B illustrates a detailed block diagram of reconstruction part 405 of NN-based in-loop filter 122 of FIG. 4, according to some embodiments of the present disclosure. Reconstruction part 405 in FIG. 6B may receive global features (gl fea) 602 from backbone part 403 and use a 64×2 convolutional layer (Conv(64,2)) to reduce the channel dimension of the global features 602 to obtain a residual map. Finally, the obtained residual map may be added by a summation layer (shown in FIG. 4) to reconstruction frame 401, thereby generating an enhanced reconstruction frame 418.

Referring back to FIG. 4, consistent with the scope of the present disclosure, backbone part 403 of NN-based in-loop filter 122 includes at least one RAB 416 and at least one TB 417. The numbers of RABs 416 and TBs in NN-based in-loop filter 122 may vary in different implementations, for example, based on different types of input reconstruction frames 401 (e.g., with different image samples and/or slice types). In one example, in which reconstruction frame 401 is a reconstruction frame of luma samples (e.g., in Y channel), backbone part 403 may include three RABs (RAB×3) 416 and six TBs (TB×6) 417, as shown in FIG. 7A. Three RABs 416 and six TBs 417 may be configured to process features 502 extracted from the reconstruction frame of luma samples using feature extraction part 407 in FIG. 5A to obtain global features 602. In another example in which reconstruction frame 401 is a reconstruction frame of chroma samples (e.g., in U and V channels), backbone part 403 may include one RABs (RAB×1) 416 and three TBs (TB×3) 417, as shown in FIG. 7B. One RAB 416 and three TBs 417 may be configured to process features 502 extracted from the reconstruction frame of chroma samples using feature extraction part 407 in FIG. 5B to obtain global features 602. It is understood that the numbers of RABs 416 and TBs 417 may vary in other examples.

RAB 416 and TB 417 are configured to extract and process intermediate features. In some embodiments, RAB 416 is configured to process features 502 to obtain a local correlation between features 502. For example, RAB 416 may be used to extract shallow features of input information and capture the correlation between local features. However, it may not be enough to only consider the local correlation between features. In a video frame, similar patterns often appear repeatedly. It is important to calculate the response of a single position by weighting all non-local related positions. Hence, in some embodiments, TB 417 is configured to process features 502 to obtain a long-range correlation between features 502. For example, TB 417 may be employed to capture the long-range correlation between features, thereby aiding NN-based in-loop filter 122 to acquire more effective residual features.

FIG. 14 illustrates a detailed block diagram of TB 417 of backbone part 403 of FIGS. 7A and 7B, according to some embodiments of the present disclosure. As shown in FIG. 14, TB 417 includes normalization layers (LayerNorm), a multi-head attention network (Self-attention) performing spatially enriched feature interaction across channels, and a feed-forward network (Feed-froward) for controlled feature transformation, i.e., to allow useful information to propagate further, such that it can capture long-range pixel interactions, while still remaining applicable to large images.

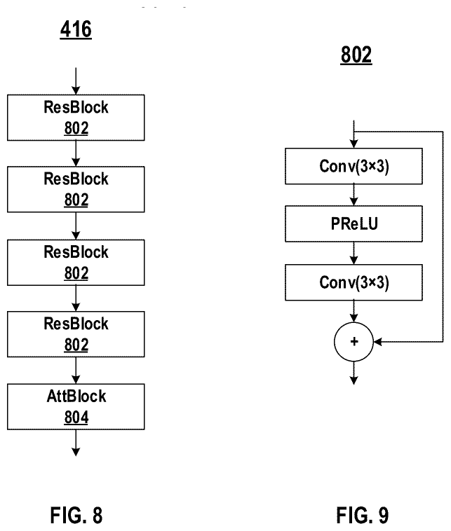

FIG. 8 illustrates a detailed block diagram of RAB 416 of backbone part 403 of FIGS. 7A and 7B, according to some embodiments of the present disclosure. RAB 416 includes at least one residual block (ResBlock) 802 (e.g., four in FIG. 8) and at least one attention block (AttBlock) 804 (e.g., one in FIG. 8). FIG. 9 illustrates a detailed block diagram of residual block 802 of RAB 416 of FIG. 8, according to some embodiments of the present disclosure. As shown in FIG. 9, residual block 802 may include a convolution layer (Conv(3×3)), a PReLU, followed by another convolution layer (Conv(3×3)). The result after the second convolution layer may be summed with the input of the first convolution layer as the output of residual block 802.

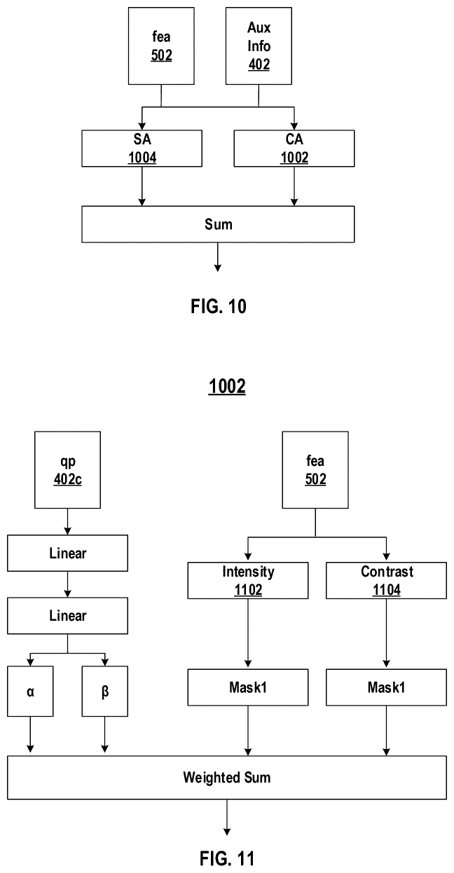

FIG. 10 illustrates a detailed block diagram of attention block 804 of RAB 416 of FIG. 8, according to some embodiments of the present disclosure. As shown in FIG. 10, besides features 502, attention block 804 also receives at least some of auxiliary information 402 (e.g., partition map 402b and QP map 402c), which can guide attention block 804 to adaptively select and refine important features. Attention block 804 includes a spatial attention block (SA) 1004 and a channel attention block (CA) 1002, and the outputs of spatial attention block 1004 and channel attention block 1002 are combined by summation as the output of attention block 804. Through these two branches, features 502 retains important feature information in the channel and spatial dimensions, respectively, with the assistance from auxiliary information 402, and then fuses the two parts of information to obtain the final output.

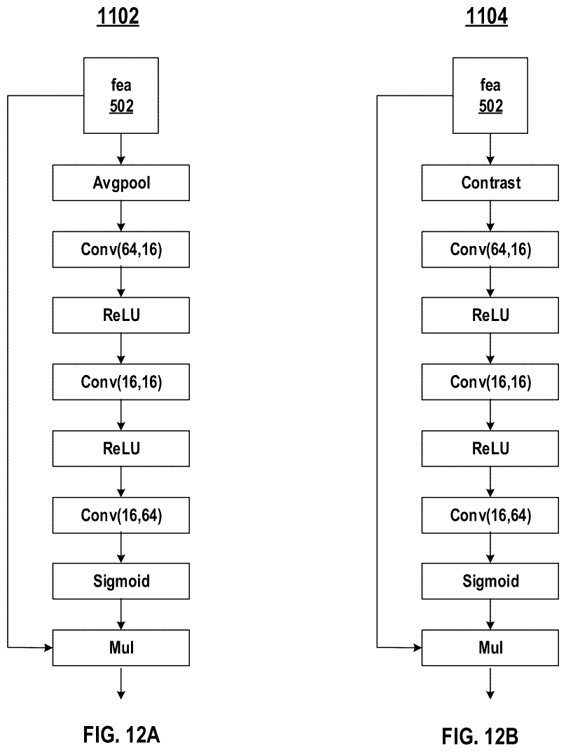

FIG. 11 illustrates a detailed block diagram of channel attention block 1002 of attention block 804 of FIG. 10, according to some embodiments of the present disclosure. Channel attention block 1002 is configured to combine intensity attention and contrast attention of reconstruction frame 401 based on QP map 402c. Intensity attention and contrast attention may be processed by intensity channel attention block (Intensity) 1102 and contrast channel attention block (Contrast) 1104, as further illustrated in FIGS. 12A and 12B, respectively. As shown in FIG. 12A, intensity channel attention block 1102 extracts the weight of each channel through global average pooling (Avgpool) and channel compression and expansion using multiple convolution layers (Conv(x,y)) and ReLus and a sigmoid layer. Then, the extracted weight is multiplied (Mul) by the input features 502 to obtain the channel attention map.

As shown in FIG. 12B, compared with intensity channel attention block 1102, the main difference of contrast channel attention block 1104 is that the input is the sum of the mean and variance of features 502, rather than the result of global average pooling. The calculation process of mean and variance is shown in the following formula:

$$mean = \frac{1}{H \times W} {\sum }_{i , j ∈ H , W} {F}_{i , j} ,$$

$$and$$

$$var = \sqrt{\frac{1}{H \times W} {\sum }_{i , j ∈ H , W} {( {F}_{i , j} - mean )}^{2}} .$$

In the high-level field, the importance of a feature map depends on activated high-value areas, since global average pooling is utilized to capture the global information. Although the average pooling can indeed improve the peak signal-to-noise ratio (PSNR) value, it lacks the information about structures, textures, and edges that are propitious to enhance image details (related to structural similarity index measure (SSIM)). Therefore, contrast channel attention block 1104 replaces the global average pooling summation of standard deviation and mean (the contrast of the evaluation feature map) to complement intensity channel attention block 1102, according to some embodiments.

Referring back to FIG. 11, QP map 402c is introduced to fuse the results of intensity channel attention block 1102 and contrast channel attention block 1104 using weight summation. This is mainly due to an observation that NN-based in-loop filter 122 tends to focus on structural features for larger QP inputs, while NN-based in-loop filter 122 tends to focus on texture features for smaller QP inputs.

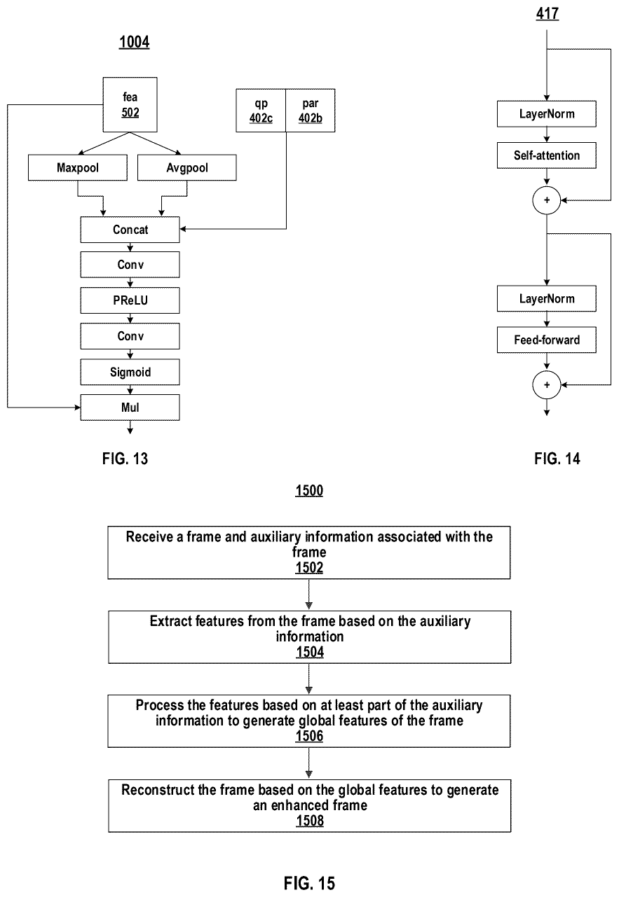

FIG. 13 illustrates a detailed block diagram of spatial attention block 1004 of attention block 804 of FIG. 10, according to some embodiments of the present disclosure. Spatial attention block 1004 is configured to locate a region of reconstruction frame 401 with blocking effect and distortion based on partition map 402b and QP map 402c. In spatial attention block 1004, the input auxiliary information 402 mainly includes partition map 402b and QP map 402c, which can better locate the region where the blocking effect and distortion are located spatially.

Meantime, feature 502 is processed by an avgpool layer and a maxpool layer to get an average-pooling map and a max-pooling map. The max-pooling map and average-pooling map can be used to merge and acquire important spatial features in the current feature map. The partition map 402b, QP map 402c, max-pooling map, and average-pooling map are first combined into a group of inputs through concatenate operations, then features are extracted through two convolution operations, and the spatial attention map is obtained through a sigmoid activation function. The attention map is finally used to emphasize important spatial features by pointwise multiplication.

FIG. 15 illustrates a flow chart of an exemplary method 1500 for enhancing quality of a frame, according to some embodiments of the present disclosure. Method 1500 may be performed by an apparatus, e.g., such as encoder 201, or any other suitable video encoding and/or compression systems. Method 1500 may include operations 1502-1508 as described below. It is understood that some of the operations may be optional, and some of the operations may be performed simultaneously, or in a different order other than shown in FIG. 15.

Referring to FIG. 15, at 1502, a frame and auxiliary information associated with the frame are received. In some embodiments, the auxiliary information includes a prediction map, a partition map, and a QP map each associated with the frame. In some embodiments, the frame is a reconstruction frame. For example, the frame is a reconstruction frame of chroma samples or luma samples. In one example, the frame and auxiliary information are received by processor 202. For example, as shown in FIG. 4, NN-based in-loop filter 122 receives reconstruction frame 401 and auxiliary information 402 including prediction map 402a, partition map 402b, and QP map 402c.

A NN-based in-loop filter is then applied to the frame based on the auxiliary information to enhance the quality of the frame. The NN-based in-loop filter includes a backbone part including at least one transformer block and at least one attention block receiving at least part of the auxiliary information. In one example, the NN-based in-loop filter is applied to the frame by processor 202. For example, as shown in FIG. 4, NN-based in-loop filter 122 is applied to reconstruction frame 401 based on auxiliary information 402 including prediction map 402a, partition map 402b, and QP map 402c. As shown in FIGS. 4 and 8, NN-based in-loop filter 122 includes backbone part 403, which includes at least one TB 417 and at least on RAB 416. RAB 416 includes at least one attention block 804. As shown in FIGS. 11 and 13, attention block 804 receives at least some of auxiliary information 402 including partition map 402b and QP map 402c.

To apply the NN-based in-loop filter to the frame, at 1504, features are extracted from the frame based on the auxiliary information, for example, using a feature extraction part of the NN-based in-loop filter. In some embodiments, to extract the features from a reconstruction frame of chroma samples, the features are extracted from the reconstruction frame of chroma samples based on the auxiliary information and a reconstruction frame of luma samples using the feature extraction part. For example, as shown in FIG. 5A and 5B, features 502 are extracted from reconstruction frame 401 based on auxiliary information 402 using feature extraction part 407 of NN-based in-loop filter 122.

To apply the NN-based in-loop filter to the frame, at 1506, the features are processed based on the at least part of the auxiliary information to generate global features of the frame using the backbone part. For example, as shown in FIGS. 7A and 7B, backbone part 403 includes RABs 416 and TBs 417, and features 502 are processed by RABs 416 and TBs 417 and backbone part 403 to generate global features 602 of reconstruction frame 401.

In some embodiments, the features are processed based on the partition map and the QP map using the at least one attention block. In one example, a region of the frame with blocking effect and distortion is located based on the partition map and the QP map using the spatial attention block, and intensity attention and contrast attention of the frame are combined based on the QP map using the channel attention block. For example, as shown in FIGS. 11 and 13, spatial attention block 1004 locates the region of reconstruction frame 401 with blocking effect and distortion based on partition map 402b and QP map 402c, and channel attention block 1002 combines intensity attention and contrast attention of reconstruction frame 401 based on QP map 402c.

In some embodiments, the features are processed to obtain a local correlation between the features using the residual block and the attention block. For example, as shown in FIGS. 7A, 7B, and 8-13, RAB 416 process features 502 to obtain a local correlation between features 502. In some embodiments, the features are processed to obtain a long-range correlation between the features using the transformer block. For example, as shown in FIGS. 7A, 7B, and 14, TB 417 process features 502 to obtain a long-range correlation between features 502.

At 1508, the frame is reconstructed based on the global features to generate an enhanced frame using the reconstruction part. In one example, the frame is reconstructed based on the global features to generate an enhanced frame by processor 202. For example, as shown in FIG. 4, 6A, and 6B, reconstruction part 405 of NN-based in-loop filter 122 reconstructs reconstruction frame 401 based on global features 602 to generate enhanced reconstruction frame 418.

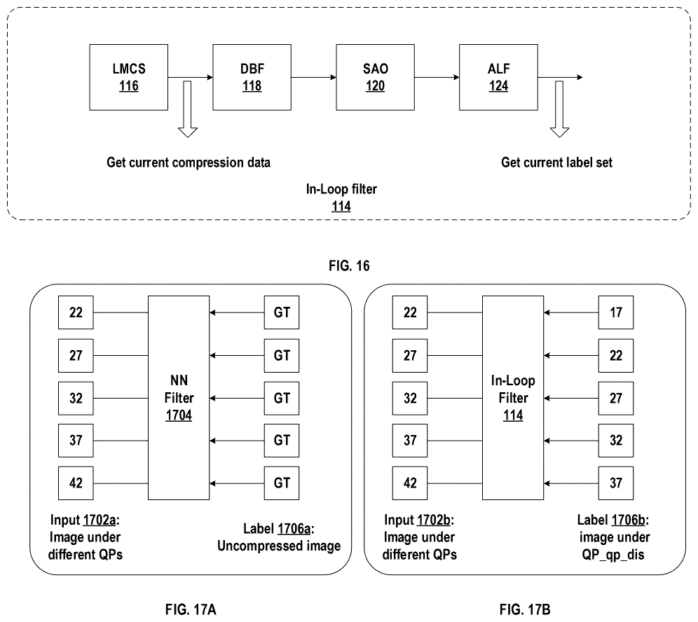

FIG. 16 illustrates a block diagram of in-loop filter 114 used for training, according to some embodiments of the present disclosure. Referring to FIG. 16, in-loop filter 114 may include an LMCS 116, a DBF 118, an SAO 120, and an ALF 124. A compressed dataset (e.g., the reconstruction frame, the prediction map, and the partition map) may be obtained after LMCS 116, while the label set may be obtained after ALF 124. The compression dataset and the label set may be used to train NN-based in-loop filter 122 described herein. To that end, a weighted L1 loss and L2 loss may be used to train NN-based in-loop filter 122 using a loss function f(x), which is shown below:

$$f ( x ) = 8 \times {Loss}_{y} + {Loss}_{u} + {Loss}_{v} ,$$

where Loss indicates L1 loss or L2 loss in the Y, U, and V channels. For example, the loss function for luma and chroma samples is expressed as follow:

$${L}_{luma} = Loss ( {rec}_{Y} - {label}_{Y} ) ,$$

$$and$$

$${L}_{chroma} = Loss ( {rec}_{U} - {label}_{U} ) + Loss ( {rec}_{V} - {label}_{V} ) .$$

In some examples, L1 loss may be used in the first and mid-training periods, and L2 loss may be used in the late training period.

FIG. 17A illustrates a block diagram of an in-loop filter training strategy for training a traditional neural network (NN) filter 1704. FIG. 17B illustrates a block diagram of an exemplary in-loop filter training strategy for training in-loop filter 114, according to some embodiments of the present disclosure. FIGS. 17A and 17B will be described together.

Referring to FIG. 17A, the network training usually takes uncompressed images as labels 1706a. However, since the inputs 1702a are compressed with different QPs, the distance between the compressed images and the labels is different, which leads to learning difficulty of the network for all training data. Moreover, the distance severely limits the overall performance of the network.

Referring to FIG. 17B, exemplary in-loop filter training strategy implemented by in-loop filter 114 maximizes the learning ability of the network using inputs 1702b (e.g., compressed images) with different QPs. For the inputs 1702b with current QP, the lower QP compressed images are used to replace the uncompressed images as labels to train in-loop filter 114. In this way, the distance between the input 1702b and label 1706b remains consistent, thereby improving the stability of the network performance and solving the drawbacks of traditional training methods.

Still referring to FIG. 17B, the training strategy may set a parameter qp_dis, which represents the QP difference between the input 1702a and the label 1706b. Since the smaller QP represents higher quality, the QP value of label 1706b is lower than that of the input 1702b. First, the training strategy may use a smaller qp_ dis to train in-loop filter 114 until convergence. Then, the training strategy may gradually increase qp_ dis and continue to train in-loop filter 114. Since the loss function is a multi-stage loss, the training strategy combines the loss function with the training strategy to achieve a multi-stage training strategy. First, the training strategy sets qp_dis=5 and trains in-loop filter 114 with L1 and L2 loss functions successively. Then, the training strategy increases qp_dis by 10, and trains in-loop filter 114 again with L1 and L2 loss functions. After that, the training strategy again increases qp_dis and trains in-loop filter 114 with the L1 and L2 loss functions. In this way, the exemplary in-loop filter training strategy achieves network convergence and maximizes the learning ability of the training strategy.

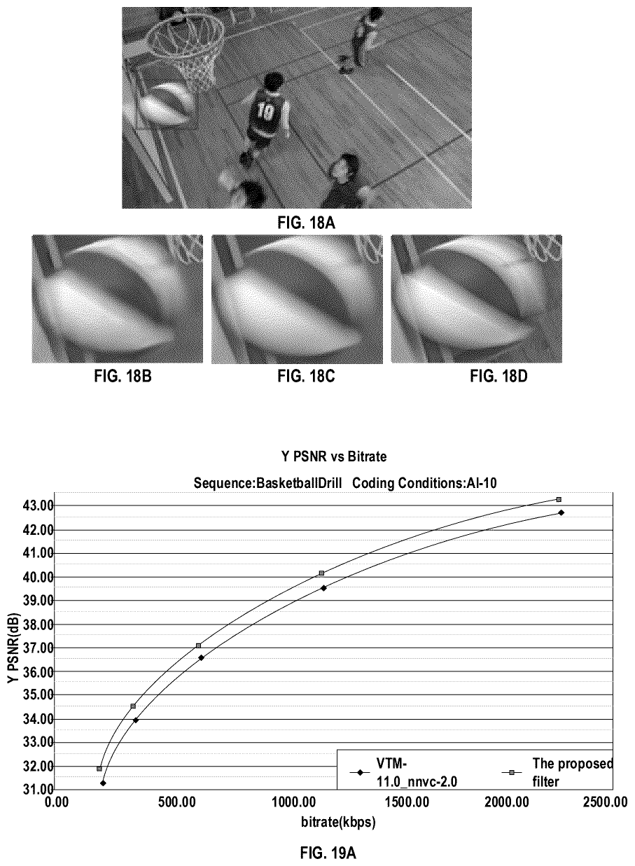

FIGS. 18A to 18D illustrate visual quality comparison on exemplary test datasets of the NN-based in-loop filter of FIG. 4, where FIG. 18A illustrates a video frame of Class C-BasketballDrill, FIG. 18B illustrates the result of VTM-11.0_NNVC-2.0, FIG. 18C illustrates the result of NN-based in-loop filter 122, and FIG. 18D illustrates ground truth. It can be observed from FIGS. 18A to 18D that NN-based in-loop filter 122 can effectively remove artifacts and blurs in the compressed image (such as the basketball) while making the edges of objects more clear.

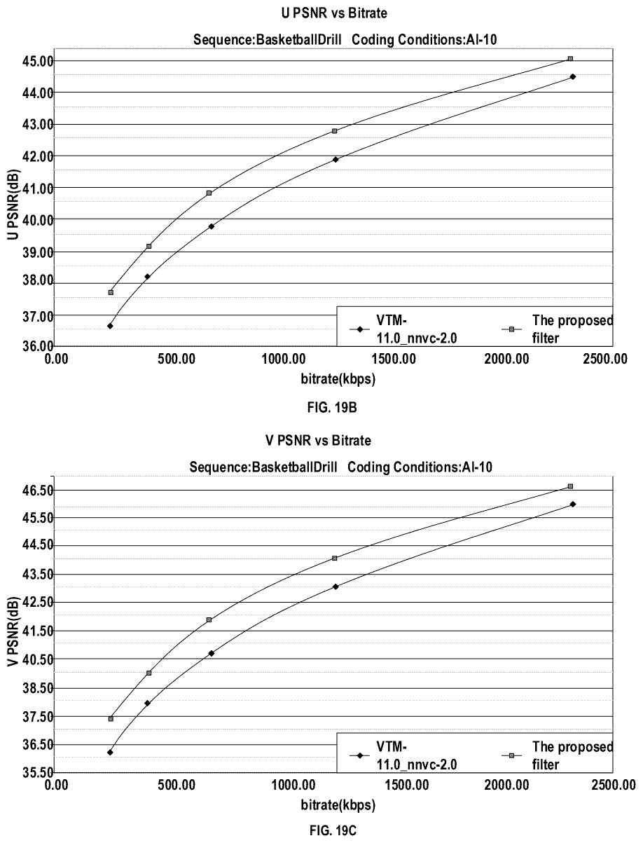

FIGS. 19A-19C illustrates test results of PSNR versus bit-rate for video encoding by test datasets of FIGS. 18A to 18D using the NN-based in-loop filter 122 of FIG. 4, according to some embodiments of the present disclosure. For example, FIG. 19A illustrates RD curve of Y channel, FIG. 19B illustrates RD curve of U channel, and FIG. 19C illustrates RD curve of V channel. As shown in FIGS. 19A-19C. NN-based in-loop filter 122 achieved significant gains.

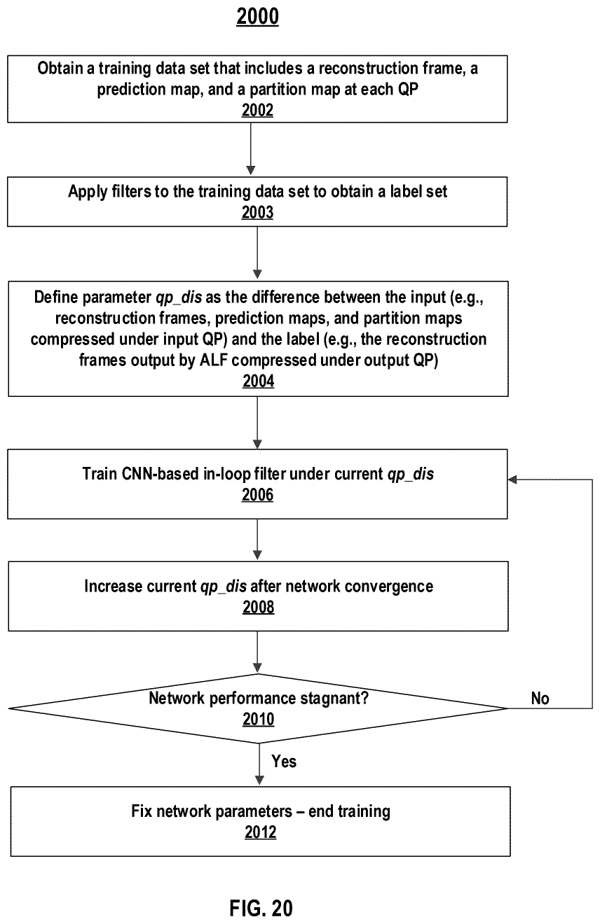

FIG. 20 illustrates a flow chart of an exemplary method 2000 of training NN-based in-loop filter 122, according to some embodiments of the present disclosure. Method 2000 may be performed by any suitable computing system. Method 2000 may include operations 2002-2012 as described below. It is understood that some of the operations may be optional, and some of the operations may be performed simultaneously, or in a different order other than shown in FIG. 20.

Referring to FIG. 20, at 2002, the apparatus may obtain, by a processor, a training data set that includes a reconstruction frame, a prediction map, and a partition map at each QP. For example, referring to FIG. 17B, the training strategy implemented by in-loop filter 114 maximizes the learning ability of the network using inputs 1702b with different QPs.

At 2003, the apparatus may apply, by the processor, filters, e.g., a DBF, an SAO, and an ALF, to the training data set. For example, referring to FIG. 16, in-loop filter 114 may include LMCS 116, DBF 118, SAO 120, and ALF 124. A compressed dataset (e.g., the reconstruction frame, the prediction map, and the partition map) may be obtained after LMCS 116, while the label set may be obtained after ALF 124. DBF 118, SAO 120, and ALF 124 may be applied to the compressed dataset to obtain the label set.

In some embodiments, the networks can be implemented in PyTorch platform. The total epochs may be 800, the batch size may be set to 32, and the learning rate may be set to 1e-4. DIV2K and BVI-DVC datasets may be used to train the proposed filter. All pictures may be compressed using VTM 11.0-NNVC under All intra (AI) and Random access (RA) configurations. Specifically, all images in DIV2K and all I frames of Class A in BVI-DVC may be compressed in AI configuration to train the I-Slice model, while all videos of Classes B, C, and D in BVI-DVC dataset may be compressed in RA configuration. Compressed images may be extracted from all compressed videos at 20 frame intervals to train the B-Slice model. It should be noted that DBF and SAO may be disabled when compressing training data for I-Slice model in AI configuration. The compressed image may be randomly cropped into a number of 144×144 patches, and random horizontal and vertical flipping may be used for data augmentation.

At 2003, the apparatus may obtain, by the processor, a label set associated with an enhanced reconstruction frame as an output of the ALF and associated with a second set of QPs smaller than the first set of QPs. For example, referring to FIG. 16, a compressed dataset (e.g., the reconstruction frame, the prediction map, and the partition map) may be obtained after LMCS 116, while the label set may be obtained after ALF 124. DBF 118, SAO 120, and ALF 124 may be applied to the compressed dataset to obtain the label set.

At 2304, the apparatus may define, by the processor, parameter qp_dis as the difference between the input (e.g., reconstruction frames, prediction maps, and partition maps compressed under input QP) and the label (e.g., the reconstruction frames output by ALF compressed under output QP). For example, referring to FIG. 17B, the training strategy may set a parameter qp_dis, which represents the QP difference between the input 1702b and the label 1706b. Since the smaller QP represents higher quality, the QP value of label 1706b is lower than that of the input 1702b.

At 2006, the apparatus may train in-loop filter 114 under the current qp_dis. For example, referring to FIG. 17B, the training strategy may use a smaller qp_ dis to train in-loop filter 114.

At 2008, the apparatus may increase current qp_dis after network convergence. For example, referring to FIG. 17B, the training strategy may use a smaller qp_ dis to in-loop filter 114 until convergence. Then, the training strategy may gradually increase qp_ dis and continue to train in-loop filter 114. Since the loss function is a multi-stage loss, the training strategy combines the loss function with the training strategy to achieve a multi-stage training strategy. First, the training strategy sets qp_dis=5 and trains in-loop filter 114 with L1 and L2 loss functions successively. Then, the training strategy increases qp_dis by 10, and trains in-loop filter 114 again with L1 and L2 loss functions. After that, the training strategy again increases qp_dis and trains in-loop filter 114 with the L1 and L2 loss functions.

At 2010, the apparatus may determine whether the network performance is stagnant. For example, referring to FIG. 17B, the training strategy may determine whether its performance increases with subsequent training using an increased qp_dis. If not, the operations may return to 2006; if yes, the operations may move to 2012.

At 2012, the apparatus may fix the network parameters and end training. For example, referring to FIG. 17B, once the network parameters are fixed, NN-based in-loop filter 122 used by in-loop filter 114 is generated. In this way, the in-loop filter training strategy achieves network convergence and maximizes the learning ability.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 202 in FIGS. 2 and 3. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method for enhancing quality of a frame is provided. The frame and auxiliary information associated with the frame are received by a processor. A NN-based in-loop filter is applied to the frame based on the auxiliary information to enhance the quality of the frame. The NN-based in-loop filter includes a backbone part including at least one transformer block and at least one RAB. The at least one RAB includes at least one attention block receiving at least part of the auxiliary information.

In some embodiments, the auxiliary information includes a prediction map, a partition map, and a QP map each associated with the frame.

In some embodiments, the NN-based in-loop filter further includes a feature extraction part. In some embodiments, to apply the NN-based in-loop filter, features are extracted from the frame based on the auxiliary information using the feature extraction part.

In some embodiments, the frame is a reconstruction frame of chroma samples. In some embodiments, to extract the features from the frame, the features are extracted from the reconstruction frame of chroma samples based on the auxiliary information and a reconstruction frame of luma samples using the feature extraction part.

In some embodiments, the at least part of the auxiliary information includes a partition map and a QP map each associated with the frame. In some embodiments, to apply the NN-based in-loop filter, the features are processed based on the partition map and the QP map using the at least one attention block.

In some embodiments, the at least one attention block includes a spatial attention block and a channel attention block. In some embodiments, to process the features, a region of the frame with blocking effect and distortion is located based on the partition map and the QP map using the spatial attention block, and intensity attention and contrast attention of the frame are combined based on the QP map using the channel attention block.

In some embodiments, the RAB further includes at least one residual block. In some embodiments, to apply the NN-based in-loop filter, the features are processed to obtain a local correlation between the features using the RAB, and the features are processed to obtain a long-range correlation between the features using the transformer block.

In some embodiments, the frame is a reconstruction frame of luma samples, and the backbone part includes three attention blocks and six transformer blocks.

In some embodiments, the frame is a reconstruction frame of chroma samples, and the backbone part includes one attention block and three transformer blocks.

In some embodiments, the NN-based in-loop filter further includes a reconstruction part. In some embodiments, to apply the NN-based in-loop filter, the features are processed based on the at least part of the auxiliary information to generate global features of the frame using the backbone part, and the frame are reconstructed based on the global features to generate an enhanced frame using the reconstruction part.

According to another aspect of the present disclosure, a system for enhancing quality of a frame includes a memory configured to store instructions and a processor coupled to the memory. The processor is configured to, upon executing the instructions, receive the frame and auxiliary information associated with the frame, and apply a NN-based in-loop filter to the frame based on the auxiliary information to enhance the quality of the frame. The NN-based in-loop filter includes a backbone part including at least one transformer block and at least one RAB. The at least one RAB includes at least one attention block receiving at least part of the auxiliary information.

In some embodiments, the auxiliary information includes a prediction map, a partition map, and a QP map each associated with the frame.

In some embodiments, the NN-based in-loop filter further includes a feature extraction part. In some embodiments, to apply the NN-based in-loop filter, the processor is further configured to extract features from the frame based on the auxiliary information using the feature extraction part.

In some embodiments, the frame is a reconstruction frame of chroma samples. In some embodiments, to extract the features from the frame, the processor is further configured to extract the features from the reconstruction frame of chroma samples based on the auxiliary information and a reconstruction frame of luma samples using the feature extraction part.

In some embodiments, the at least part of the auxiliary information includes a partition map and a QP map each associated with the frame. In some embodiments, to apply the NN-based in-loop filter, the processor is further configured to process the features based on the partition map and the QP map using the at least one attention block.

In some embodiments, the at least one attention block includes a spatial attention block and a channel attention block. In some embodiments, to process the features, the processor is further configured to locate a region of the frame with blocking effect and distortion based on the partition map and the QP map using the spatial attention block, and combine intensity attention and contrast attention of the frame based on the QP map using the channel attention block.

In some embodiments, the RAB further includes at least one residual block. In some embodiments, to apply the NN-based in-loop filter, the processor is further configured to process the features to obtain a local correlation between the features using the RAB, and process the features to obtain a long-range correlation between the features using the transformer block.

In some embodiments, the frame is a reconstruction frame of luma samples, and the backbone part includes three attention blocks and six transformer blocks.

In some embodiments, the frame is a reconstruction frame of chroma samples, and the backbone part includes one attention block and three transformer blocks.

According to still another aspect of the present disclosure, a non-transitory computer-readable device is provided. The non-transitory computer-readable device has instructions stored thereon that, when executed by at least one computing device, cause the at least one computing device to perform operations. The operations include receiving a frame and auxiliary information associated with the frame, and applying a NN-based in-loop filter to the frame based on the auxiliary information to enhance the quality of the frame. The NN-based in-loop filter includes a backbone part including at least one transformer block and at least one RAB. The at least one RAB includes at least one attention block receiving at least part of the auxiliary information.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method for enhancing quality of a frame, comprising:
receiving, by a processor, the frame and auxiliary information associated with the frame; and
applying, by the processor, a neural network (NN)-based in-loop filter to the frame based on the auxiliary information to enhance the quality of the frame, wherein the NN-based in-loop filter comprises a backbone part comprising at least one transformer block and at least one residual-attention block (RAB), and the at least one RAB comprises at least one attention block receiving at least part of the auxiliary information.

2. The method of claim 1, wherein the auxiliary information comprises a prediction map, a partition map, and a quantization parameter (QP) map each associated with the frame.

3. The method of claim 1, wherein
the NN-based in-loop filter further comprises a feature extraction part; and
applying the NN-based in-loop filter comprises extracting features from the frame based on the auxiliary information using the feature extraction part.

4. The method of claim 3, wherein
the frame is a reconstruction frame of chroma samples; and
extracting the features from the frame comprises extracting the features from the reconstruction frame of chroma samples based on the auxiliary information and a reconstruction frame of luma samples using the feature extraction part.

5. The method of claim 3, wherein
the at least part of the auxiliary information comprises a partition map and a QP map each associated with the frame; and
applying the NN-based in-loop filter comprises processing the features based on the partition map and the QP map using the at least one attention block.

6. The method of claim 5, wherein
the at least one attention block comprises a spatial attention block and a channel attention block; and
processing the features comprises:
locating a region of the frame with blocking effect and distortion based on the partition map and the QP map using the spatial attention block; and
combining intensity attention and contrast attention of the frame based on the QP map using the channel attention block.

7. The method of claim 3, wherein
the RAB further comprises at least one residual block; and
applying the NN-based in-loop filter comprises:
processing the features to obtain a local correlation between the features using the RAB; and
processing the features to obtain a long-range correlation between the features using the transformer block.

8. The method of claim 1, wherein
the frame is a reconstruction frame of luma samples; and
the backbone part comprises three attention blocks and six transformer blocks.

9. The method of claim 1, wherein
the frame is a reconstruction frame of chroma samples; and
the backbone part comprises one attention block and three transformer blocks.

10. The method of claim 3, wherein
the NN-based in-loop filter further comprises a reconstruction part; and
applying the NN-based in-loop filter comprises:
processing the features based on the at least part of the auxiliary information to generate global features of the frame using the backbone part; and
reconstructing the frame based on the global features to generate an enhanced frame using the reconstruction part.

11. A system for enhancing quality of a frame, comprising:
a memory configured to store instructions; and
a processor coupled to the memory and configured to, upon executing the instructions:
receive the frame and auxiliary information associated with the frame; and
apply a neural network (NN)-based in-loop filter to the frame based on the auxiliary information to enhance the quality of the frame, wherein the NN-based in-loop filter comprises a backbone part comprising at least one transformer block at least one residual attention block (RAB), and the at least one RAB comprises at least one attention block receiving at least part of the auxiliary information.

12. The system of claim 11, wherein the auxiliary information comprises a prediction map, a partition map, and a quantization parameter (QP) map each associated with the frame.

13. The system of claim 11, wherein
the NN-based in-loop filter further comprises a feature extraction part; and
to apply the NN-based in-loop filter, the processor is further configured to extract features from the frame based on the auxiliary information using the feature extraction part.

14. The system of claim 13, wherein
the frame is a reconstruction frame of chroma samples; and
to extract the features from the frame, the processor is further configured to extract the features from the reconstruction frame of chroma samples based on the auxiliary information and a reconstruction frame of luma samples using the feature extraction part.

15. The system of claim 13, wherein
the at least part of the auxiliary information comprises a partition map and a QP map each associated with the frame; and
to apply the NN-based in-loop filter, the processor is further configured to process the features based on the partition map and the QP map using the at least one attention block.

16. The system of claim 15, wherein
the at least one attention block comprises a spatial attention block and a channel attention block; and
to process the features, the processor is further configured to:
locate a region of the frame with blocking effect and distortion based on the partition map and the QP map using the spatial attention block; and
combine intensity attention and contrast attention of the frame based on the QP map using the channel attention block.

17. The system of claim 13, wherein
the RAB further comprises at least one residual block; and
to apply the NN-based in-loop filter, the processor is further configured to:
process the features to obtain a local correlation between the features using the RAB; and
process the features to obtain a long-range correlation between the features using the transformer block.

18. The system of claim 11, wherein
the frame is a reconstruction frame of luma samples; and
the backbone part comprises three attention blocks and six transformer blocks.

19. The system of claim 11, wherein
the frame is a reconstruction frame of chroma samples; and
the backbone part comprises one attention block and three transformer blocks.

20. A non-transitory computer-readable device having instructions stored thereon that, when executed by at least one computing device, cause the at least one computing device to perform operations comprising:
receiving a frame and auxiliary information associated with the frame; and
applying a neural network (NN)-based in-loop filter to the frame based on the auxiliary information to enhance quality of the frame, wherein the NN-based in-loop filter comprises a backbone part comprising at least one transformer block at least one residual-attention block (RAB), and the at least one RAB comprises at least one attention block receiving at least part of the auxiliary information.
